(19) United States
(12) Patent Application Publication
(10) Pub. No.: US 2014/0352537 A1
(43) Pub. Date: Dec. 4, 2014

(54) AIR PURIFICATION SYSTEM FOR A VEHICLE

(71) Applicant: Arkema France, Colombes (FR)

(72) Inventors: Philippe Bonnet, Lyon (FR); Laurent Wendlinger, Soucieu En Jarrest (FR)

(73) Assignee: ARKEMA FRANCE, Colombes (FR)

(21) Appl. No.: 14/372,866

(22) PCT Filed: Feb. 29, 2012
(86) PCT No.: PCT/IB2012/000513

§ 371 Date: Jul. 17, 2014

(51) Int. Cl. B60H 3/06; B01D 53/04

(52) U.S. Cl. CPC B60H 3/06; B01D 53/0407; B60H 2003/0691; B01D 2257/20; B01D 2253/10
USPC 95/131; 454/158

(57) ABSTRACT

A method for purifying air in the cabin of a vehicle, including filtering the air through a filter system, wherein the vehicle includes an air conditioning circuit containing a fluorinated refrigerant compound, and the filter system includes a filtering material which is adapted for removing hydrogen fluoride from a gas flow. Also, a vehicle in which this method can be implemented.

### TECHNICAL FIELD

The disclosure relates to a method for purifying air in the cabin of a vehicle, as well as to a vehicle comprising an air purification system.

### TECHNICAL BACKGROUND

Air purifications systems for vehicles are known in the prior art. Such devices have been adapted to filter the air and to remove most of all particulates such as pollen, dust or exhaust gases that pass through the filter. Document US 2007/0032186 provides an example of such an air purification system.

However, conventional air purification systems are not designed to adequately remove harmful contaminants which are potentially contained in fumes and gases produced during a fire in the engine compartment.

Fluorinated organic compounds, including chlorofluorocarbons (CFCs), hydrochlorofluorocarbons (HCFCs) hydrofluorocarbons (HFCs) and more recently hydrofluoroolefins (HFOs) have been developed as safe and non-toxic refrigerants in vehicle air-conditioning systems.

However, there has been some concern that these fluorinated compounds may burn and/or decompose and thus form highly toxic hydrogen fluoride (HF) in case of a fire in the engine compartment, where the temperature can reach a value as high as 1200° C.

Such concern has especially been expressed with respect to the newly used compound 2,3,3,3-tetrafluoropropene (HFO-1234yf). Even though it is considered at present that such a risk is purely theoretical, since HFO-1234yf is only mildly flammable, it would still be desirable to increase the safety of vehicles comprising air conditioning systems containing a fluorinated refrigerant compound even further.

### SUMMARY

It is a first object of the disclosure to provide a method for purifying air in the cabin of a vehicle, comprising filtering the air through a filter system, wherein the vehicle comprises an air conditioning circuit containing a fluorinated refrigerant compound, and the filter system comprises a filtering material which is adapted for removing hydrogen fluoride from a gas flow.

According to one embodiment, the filtering material comprises an inorganic material, preferably selected from:
alkali metal derivatives, such as lithium fluoride, sodium fluoride, potassium fluoride and sodium carbonate;
alkaline earth metal derivatives, such as calcium hydroxide, calcium oxide, calcium carbonate, magnesium oxide, magnesium carbonate, barium carbonate, calcium chloride, calcium lactate;
transition metal derivatives, such as chromium trifluoride, titanium dioxide, manganese dioxide;
other metal derivatives, such as alumina and aluminum fluoride;
semimetal derivatives, such as silica, modified silica, dehydroxylated silica, silica aerogel;
molecular sieves, such as aluminosilicates, zeolites and aluminophosphates; and
combinations thereof.

According to one embodiment, the filtering material comprises a polymer resin, preferably selected from sodium polyacrylate polymers, tetrafluoroethylene polymers comprising perfluorovinyl ether groups terminated with sulfonate groups, polyolefin microporous membranes, and combinations thereof.

According to one embodiment, the filtering material comprises a carbon-based material, preferably selected from activated carbon, carbon molecular sieves, carbon nanotubes, graphene, aluminum-doped graphene, diamond, and combinations thereof.

According to one embodiment, the fluorinated refrigerant compound is selected from chlorofluorocarbons, hydrochlorofluorocarbons, hydrofluorocarbons, hydrofluoroolefins and combinations thereof, and is preferably 2,3,3,3-tetrafluoropropene.

According to one embodiment, the filtering material is adapted for removing hydrogen fluoride from a gas flow by adsorption.

According to one embodiment, the filter system further comprises filters adapted for removing further gas compounds and/or particulates.

According to one embodiment, the air is filtered when it is moved from the exterior of the cabin to the interior of the cabin.

According to one embodiment, the air is moved through an air intake system which is located next to a housing containing the air conditioning circuit.

According to one embodiment, the vehicle is a car, a truck, a bus, a van, a tractor or a recreational vehicle.

It is a second object of the disclosure to provide a vehicle comprising:
a cabin;
an air conditioning circuit containing a fluorinated refrigerant compound; and
an air purification device which comprises a filter system, the filter system comprising a filtering material which is adapted for removing hydrogen fluoride from a gas flow.

According to one embodiment, the filtering material comprises an inorganic material, preferably selected from:
alkali metal derivatives, such as lithium fluoride, sodium fluoride, potassium fluoride and sodium carbonate;
alkaline earth metal derivatives, such as calcium hydroxide, calcium oxide, calcium carbonate, magnesium oxide, magnesium carbonate, barium carbonate, calcium chloride, calcium lactate;
transition metal derivatives, such as chromium trifluoride, titanium dioxide, manganese dioxide;
other metal derivatives, such as alumina and aluminum fluoride;
semimetal derivatives, such as silica, modified silica, dehydroxylated silica, silica aerogel;
molecular sieves, such as aluminosilicates, zeolites and aluminophosphates; and
combinations thereof.

According to one embodiment, the filtering material comprises a polymer resin, preferably selected from sodium polyacrylate polymers, tetrafluoroethylene polymers comprising perfluorovinyl ether groups terminated with sulfonate groups, polyolefin microporous membranes, and combinations thereof.

According to one embodiment, the filtering material comprises a carbon-based material, preferably selected from activated carbon, carbon molecular sieves, carbon nanotubes, graphene, aluminum-doped graphene, diamond, and combinations thereof.

According to one embodiment, the fluorinated refrigerant compound is selected from chlorofluorocarbons, hydrochlorofluorocarbons, hydrofluorocarbons, hydrofluoroolefins and combinations thereof, and is preferably 2,3,3,3-tetrafluoropropene.

According to one embodiment, the filtering material is adapted for removing hydrogen fluoride by adsorption.

According to one embodiment, the filter system further comprises filters adapted for removing further gas compounds and/or particulates.

According to one embodiment, the vehicle comprises an air intake system for passing air from the exterior of the cabin to the interior of the cabin, wherein the air purification device is located within the air intake system.

According to one embodiment, the air intake system comprises an air inlet which is located next to a housing containing the air conditioning circuit.

According to one embodiment, the vehicle is a car, a truck, a bus, a van, a tractor or a recreational vehicle.

The disclosure provides a system which improves the safety of vehicles comprising air conditioning systems containing a fluorinated refrigerant compound.

This is achieved owing to an air purification device which comprises a filter system adapted for removing hydrogen fluoride from a gas flow. Thus, in case of a fire in the engine compartment, and even in the unlikely event that hydrogen fluoride were released from the engine compartment and entered the cabin, said hydrogen fluoride would then be removed from the air so that it could not harm the driver or passengers.

### DESCRIPTION OF EMBODIMENTS

The disclosure will now be described in more detail without limitation in the following description.

The disclosure is directed to an air purification device which may be connected or mounted to the structural components of a vehicle and which filters the cabin air, and which preferably filters the air which enters the cabin.

A cabin of a vehicle is defined as an enclosed space in which the driver and/or the passengers are accommodated.

The air purification device generally comprises a housing and a filter system comprising a filtering material which is preferably a solid adsorbent.

The solid adsorbent may be selected from inorganic materials, polymeric resins and carbon based materials.

Among inorganic materials, the following materials have been proposed as being able to remove HF from a gas flow:
Alkali metal (more specifically Li, Na, K) derivatives, such as fluorides, hydrofluorides, carbonates, oxides or hydrogen carbonates. Particular examples are LiF, NaF, KF, and Na₂CO₃;
Alkaline earth (more specifically Mg, Ca, Ba, Sr) derivatives, such as fluorides, chlorides, carbonates, oxides, hydroxides or sulfates. Particular examples are Ca(OH)₂, CaO, CaCO₃, CaF₂, MgO, MgCO₃, BaCO₃, high surface CaCl₂, calcium lactate;
Transition metal (more specifically, Ti, Zr, Cr, Mn) derivatives, such as fluorides, oxides or hydroxides. Particular examples are CrF₃, TiO₂ and MnO₂.
Other metal (principally Al) derivatives, such as alumina or aluminum fluoride.
Semimetal (principally Si) derivatives, such as silica, modified silica, dehydroxylated silica or silica aerogel; and
Molecular sieves such as aluminosilicates, zeolites and aluminophosphates.

All these products can be used as powders, granulates or flakes. They can also be impregnated on paper, woven or unwoven cloth of natural or synthetic filaments, spongy gum or plastics.

Among polymeric resins, the following have been proposed as being able to remove HF from a gas flow:
NAFION® superacid resins (which are tetrafluoroethylene polymers comprising perfluorovinyl ether groups terminated with sulfonate groups);
Sodium polyacrylate resins; and
Various ion exchange resins, including non-functional resins (like polyolefin microporous membranes).

Among carbon based materials, the following materials have been proposed as being able to remove HF from a gas flow: activated carbon, carbon molecular sieves, carbon nanotubes, graphene (and Al-doped graphene) and even diamond.

In terms of physical characteristics, activated carbon can be manufactured with a high surface area. Besides, activated carbon can be compressed into easily usable shaped articles, such as pellets. Carbon molecular sieves and carbon nanotubes also have a pore size and a surface area which are determined by the manufacturing process, hence they can be selected for the particular application of the patent at stake.

The air purification device described above is provided in a vehicle, such as a car, a truck, a bus, a van, a tractor or a recreational vehicle for instance.

The vehicle comprises an air conditioning system having a refrigerant circuit. The refrigerant circuit contains a fluorinated refrigerant compound (i.e. a heat transfer compound), such as a chlorofluorocarbon, a hydrochlorofluorocarbon, a hydrofluorocarbon, a hydrofluoroolefin or a combination of those. Preferably the refrigerant compound is a hydrofluorocarbon or a hydrofluoroolefin. For instance, the refrigerant circuit may contain a tetrafluoropropene compound, such as HFO-1234yf.

In case HF were released from the refrigerant circuit (in the event of a fire), the air purification device of the disclosure makes it possible to prevent the released HF from contaminating the air inside the cabin. The driver and passengers are thus protected.

Some of the above materials are adapted for filtering HF as well as other fluorinated compounds, such as the fluorinated refrigerant itself (for instance HFO-1234yf). Others are more specifically directed to the removal of HF only, which is the most dangerous contaminant. This is the case for NaF for instance. Therefore, any risk of saturating the filter with non-HF contaminants is avoided.

Any position of the air purification device within the cabin can be contemplated. For instance, the air purification device can be incorporated in an air recirculation system.

However, according to a preferred embodiment, it is placed at one air entry point of the cabin (provided with an air intake system), or at several or at all of those air entry points if appropriate. Therefore, substantially no HF will enter the cabin.

Generally, an air intake system comprises a conduit adapted for moving air from the exterior of the cabin to the interior of the cabin. An air mover or fan may be included in the air intake system, and the air intake system comprises an air inlet towards the exterior of the cabin and an air outlet towards the interior of the cabin. The air purification device can then be placed anywhere between the air inlet and the air outlet.

Generally, one, some or all of the air entry points are located near the engine compartment of the vehicle. For instance, in many cars, air entry points are located between the windshield and the hood. In this case, the risk of a potential contamination of the cabin by HF emissions is slightly higher due to the proximity of the air entry points with the air conditioning circuit. It is therefore particularly appropriate to place one or more air purification systems according to the disclosure at such air entry points.

It is often desirable to remove other contaminants from the air entering the cabin, such as pollen or other particulate or gaseous pollutants. Therefore, the air purification system of the disclosure may comprise other filters (in addition to the filtering material for removing HF) which are adapted for removing such pollen or pollutants. Reference may be made to US 2007/0032186 in terms of examples of such additional filters.

1. A method for purifying air in the cabin of a vehicle, the method comprising filtering the air through a filter system, wherein the vehicle comprises an air conditioning circuit containing a fluorinated refrigerant compound, and the filter system comprises a filtering material which is configured for removing hydrogen fluoride from a gas flow.

2. The method of claim 1, wherein the filtering material comprises an inorganic material selected from:
alkali metal derivatives;
alkaline earth metal derivatives;
transition metal derivatives;
alumina and aluminum fluoride;
semimetal derivatives;
molecular sieves;
and combinations thereof.

3. The method of claim 1, wherein the filtering material comprises a polymer resin.

4. The method of claim 1, wherein the filtering material comprises a carbon-based material.

5. The method of claim 1, wherein the fluorinated refrigerant compound is selected from chlorofluorocarbons, hydrochlorofluorocarbons, hydrofluorocarbons, hydrofluoroolefins and combinations thereof.

6. The method of claim 1, wherein the filtering material is adapted for removing hydrogen fluoride from a gas flow by adsorption.

7. The method of claim 1, wherein the filter system further comprises filters adapted for removing further gas compounds and/or particulates.

8. The method of claim 1, wherein the air is filtered when it is moved from the exterior of the cabin to the interior of the cabin.

9. The method of claim 8, wherein the air is moved through an air intake system which is located next to a housing containing the air conditioning circuit.

10. The method of claim 1, wherein the vehicle is a car, a truck, a bus, a van, a tractor or a recreational vehicle.

11. A vehicle comprising:
a cabin;
an air conditioning circuit containing a fluorinated refrigerant compound;
an air purification device which comprises a filter system, the filter system comprising a filtering material which is configured for removing hydrogen fluoride from a gas flow.

12. The vehicle of claim 11, wherein the filtering material comprises an inorganic material selected from:
alkali metal derivatives;
alkaline earth metal derivatives;
transition metal derivatives;
alumina and aluminum fluoride;
semimetal derivatives;
molecular sieves;
and combinations thereof.

13. The vehicle of claim 11, wherein the filtering material comprises a polymer resin.

14. The vehicle of claim 11, wherein the filtering material comprises a carbon-based material.

15. The vehicle of claim 11, wherein the fluorinated refrigerant compound is selected from chlorofluorocarbons, hydrochlorofluorocarbons, hydrofluorocarbons, hydrofluoroolefins and combinations thereof.

16. The vehicle of claim 11, wherein the filtering material is adapted for removing hydrogen fluoride by adsorption.

17. The vehicle of claim 11, wherein the filter system further comprises filters adapted for removing further gas compounds and/or particulates.

18. The vehicle of claim 11, comprising an air intake system for passing air from the exterior of the cabin to the interior of the cabin, wherein the air purification device is located within the air intake system.

19. The vehicle of claim 18, wherein the air intake system comprises an air inlet which is located next to a housing containing the air conditioning circuit.

20. The vehicle of claim 11, wherein the vehicle is a car, a truck, a bus, a van, a tractor or a recreational vehicle.
